(19) United States
(12) Patent Application Publication
(10) Pub. No.: US 2005/0179789 A1
(43) Pub. Date: Aug. 18, 2005

(54) Color image processing method, and color imaging apparatus

(76) Inventor: Yosuke Horie, Fukuoka (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/031,759

(22) Filed: Jan. 7, 2005

(30) Foreign Application Priority Data
Jan. 9, 2004 (JP) P2004-003979
Jan. 6, 2005 (JP) P2005-001187

(51) Int. Cl. H04N 9/73

(52) U.S. Cl. 348/223.1

(57) ABSTRACT

In a image processing method capable of applying the white balance adjustment to image data upon shooting, a range of a color component region where no white balance adjustment is carried out is changed to provide an optimum white balance adjustment irrespective of exposure time upon shooting with suppression of the color rolling phenomenon. An imaging apparatus is also disclosed which includes a image processing circuit in which a range of a color component region where no white balance adjustment is carried out is changed.

### CROSS REFERENCE TO RELATED APPLICATION

This application claims priority from Japanese Priority Document No. 2004-003979, filed on Jan. 9, 2004, and P2005-001187 filed Jan. 6, 2005, with the Japanese Patent Office, which documents are hereby incorporated by reference.

### BACKGROUND OF THE INVENTION

1. Field of the Invention

The present invention relates to a color image processing method and a color imaging apparatus including a color image processing circuit.

2. Description of Related Art

Conventionally, color imaging apparatuses such as digital cameras and color video cameras include a color image processing circuit for, upon shooting or taking an object, determining a white color by automatically adjusting the value of the spectrum characteristic (a ratio of three primary color components, namely, red, green, and blue) in accordance with the type of an illumination light source (hereinafter referred to as white balance adjustment). Japanese Laid-Open Patent Publication No. 8-186828 discloses such color image processing circuit as described above.

The color imaging apparatus including such color image processing circuit determines a white color (signal) by performing the white balance adjustment in a method described blow.

First, as shown in FIG. 6, in a color imaging apparatus, sensitivity of the white balance adjustment is determined by setting an insensitive region 100 that is a color component region where no white balance adjustment is carried out.

The axis of ordinate in FIG. 6 represents a red color component, and the axis of abscissa represents a blue color component.

After that, color component data included in an image are obtained by a detection circuit for detecting color data of the image from the image data. The value of the spectrum characteristic of the illumination light source is calculated from the color component data.

Next, it is judged whether the value of the spectrum characteristic of the illumination light source is inside or outside the previously determined insensitive region 100.

If the value of the spectrum characteristics of the illumination light source is inside the insensitive region 100 (a point 101 in FIG. 6), deviation in the value of the spectrum characteristic is considered to be small, so that the value indicates a color component that gives visually no unnatural feeling to the human beings, and this results the termination of the white balance adjustment.

On the other hand, if the value of the spectrum characteristic of the illumination light source is outside the insensitive region 100 (a point 102 in FIG. 6), deviation in the value of the spectrum characteristic is considered to be large, so that the value indicates a color component that gives visually an unnatural feeling to the human being, and this requires further execution of the white balance adjustment by shifting the value of the spectrum characteristic to inside of the insensitive region 100 to determine a white color through the white balance adjustment.

However, in the conventional color imaging apparatus, the insensitive region 100 for determining the sensitivity in the white balance adjustment is previously set and fixed, and this may cause the following drawbacks.

When an object is shot or taken under an illumination light source such as a fluorescent lamp which periodically repeats turn-on and turn-off, there is a possibility of occurrence of a so-called color rolling phenomenon where a color component of the displayed image periodically varies due to differences between a flickering period of the illumination light source and a sampling period in the color imaging apparatus.

It is known that there is a tendency that the color rolling phenomenon frequently occurs as an exposure time of the imaging device becomes shorter. Thus, if the exposure time upon shooting an image is set relatively longer in order to avoid the color rolling phenomenon, the image quality may be deteriorated because of an improper exposure.

### SUMMARY OF THE INVENTION

According to one embodiment of the present invention, in a color image processing method for a color imaging apparatus including an imaging unit for taking a color image to which an exposure interval is adjustable, a white balance amplifier for adjusting a white balance of a color video signal from the imaging unit, a detecting circuit for obtaining an image information signal out of the color video signal from the imaging unit, a motion detecting circuit for detecting a position data signal out of the color video signal from the imaging unit, and a control circuit for generating a white balance control signal based on the image information signal, wherein the white balance of the color imaging apparatus is adjusted by supplying the white balance control signal to the white balance amplifier, the motion detecting circuit supplies the position data signal for a still image, and in the white balance at the image area of the position data signal for the still image, a color component range defined by a threshold value from which an adjustment for the white balance amplifier is started is changed based on the exposure interval and the color component data.

According to another embodiment of the present invention, the color component range where the white balance is not carried out is gradually narrowed as the exposure time becomes shorter.

According to further another embodiment of the present invention, the color component region where no white balance is carried out is changed only with respect to yellow and blue color components.

According to still further embodiment of the present invention, in a color imaging apparatus including an imaging unit for taking a color image to which an exposure interval is adjustable, a white balance amplifier for adjusting a white balance of a color video signal from the imaging unit, a detecting circuit for obtaining an image information signal out of the color video signal from the imaging unit, a motion detecting circuit for detecting a position data signal out of the color video signal from the imaging unit, and a control circuit for generating a white balance control signal based on the image information signal, wherein the white balance of the color imaging apparatus is adjusted by supplying the white balance control signal to the white balance amplifier, the motion detecting circuit supplies the position data signal for a still image, and in the white balance at the image area of the position data signal for the still image, a color component range defined by a threshold value from which an adjustment for the white balance amplifier is started is changed based on the exposure interval and the color component data.

Thus, the present invention provides the following advantages.

According to the embodiment of the present invention, in the color image processing method for the color imaging apparatus including the imaging unit for taking the color image to which the exposure interval is adjustable, the white balance amplifier for adjusting the white balance of the color video signal from the imaging unit, the detecting circuit for obtaining the image information signal out of the color video signal from the imaging unit, the motion detecting circuit for detecting the position data signal out of the color video signal from the imaging unit, and the control circuit for generating the white balance control signal based on the image information signal, wherein the white balance of the color imaging apparatus is adjusted by supplying the white balance control signal to the white balance amplifier, the motion detecting circuit supplies the position data signal for a still image, and in the white balance at the image area of the position data signal for the still image, the color component range defined by a threshold value from which an adjustment for the white balance amplifier is started is changed based on the exposure interval and the color component data, so that the color rolling phenomenon is efficiently suppressed.

According to still further embodiment of the present invention, the range of the color component region where no white balance adjustment is carried out is gradually narrowed as the exposure time becomes shorter. This allows the exposure time to be adjusted to a proper exposure time while suppressing the color rolling phenomenon that has a tendency of its occurrence with the variation of the exposure time, and resultantly it is able to improve the image quality.

According to still further embodiment of the present invention, the range of the color component region where no white balance is carried out is changed only with respect to the yellow and blue color components. This efficiently suppresses the color rolling phenomenon while suppressing a tracking characteristic toward the variation in spectrum characteristic caused by the change of the object.

According to the other embodiment of the present invention, in a color imaging apparatus including an imaging unit for taking a color image to which an exposure interval is adjustable, a white balance amplifier for adjusting a white balance of a color video signal from the imaging unit, a detecting circuit for obtaining an image information signal out of the color video signal from the imaging unit, a motion detecting circuit for detecting a position data signal out of the color video signal from the imaging unit, and a control circuit for generating a white balance control signal based on the image information signal, wherein the white balance of the color imaging apparatus is adjusted by supplying the white balance control signal to the white balance amplifier, the motion detecting circuit supplies the position data signal for a still image, and in the white balance at the image area of the position data signal for the still image, a color component range defined by a threshold value from which an adjustment for the white balance amplifier is started is changed based on the exposure interval and the color component data.

### BRIEF DESCRIPTION OF THE DRAWINGS

The object and features of the present invention will become more readily apparent from the following detailed description taken in conjunction with the accompanying drawings, and the same or corresponding elements or parts are designated with like references throughout the drawings in which:

FIG. 1 is a block diagram of a color imaging apparatus according to one embodiment of the present invention;

FIG. 2 illustrates a flow chart describing a color image processing method according to one embodiment of the present invention;

FIGS. 3A and 3B are illustrations describing still image blocks according to one embodiment of the present invention;

FIG. 4 is an illustration describing a relation between an insensitive region and a color spectrum characteristic according to one embodiment of the present invention;

FIG. 5 is an illustration describing a relation between an exposure time and an area of the insensitive region according to one embodiment of the present invention; and

FIG. 6 is an illustration describing a relation between an insensitive region and a spectrum characteristic according to the related art.

### DETAILED DESCRIPTION OF THE PREFERRED EMBODIMENT

A color imaging apparatus according to the present invention includes an image processing unit for applying a white balance adjustment to an image signal obtained by shooting or taking an object. Particularly, the image processing unit changes, in accordance with an exposure interval upon shooting the object, a range of a color component region where no white balance adjustment is carried out. This efficiently suppresses a so-called color rolling phenomenon which tends to occur with a variation in the exposure interval.

Further, the method of processing a color image according to one embodiment of the present invention applies the white balance adjustment to an image data obtained upon shooting an object, and changes a range of a color component region where no white balance adjustment is carried out in accordance with the exposure interval determined by an electronic shutter of an imaging section upon shooting the object.

Further, by gradually narrowing the range of the color component region where no white balance adjustment is carried out as the exposure time is shortened, the occurrence of the color rolling phenomenon that tends to occur in accordance with variation in the exposure time is suppressed.

Thus, upon shooting the object, the exposure time by the electronic shutter is appropriately adjusted to improve the image quality, and this results in an optimum white balance adjustment.

Further, the range of the color component region where no white balance adjustment is carried out is changed only regarding the color region of yellow and blue components. This efficiently suppresses the color rolling phenomenon while suppressing the tracking capabilities toward changes in a spectrum characteristic caused by change of the object.

Further, when the white balance adjustment is applied to all image data obtained by successively shooting the object, all image data are divided into a plurality of image blocks. The presence or the absence of a movement of the object is detected for each image block. The white balance adjustment is applied to all the image data on the basis of the image data in the image blocks in which no movement of the object exists. Thus, only when the spectrum characteristic of the illumination light source changes, an optimum white balance adjustment can be applied to all image data.

Hereinafter, the color imaging apparatus according to one embodiment of the present invention will be described more specifically with reference to the attached drawings.

Hereinafter, particularly, the color imaging apparatus will be described with a surveillance camera apparatus. However, the color imaging apparatus according to the present invention is not limited to the surveillance camera apparatus, and thus, the present invention is applicable to any color imaging apparatus requiring the white balance control.

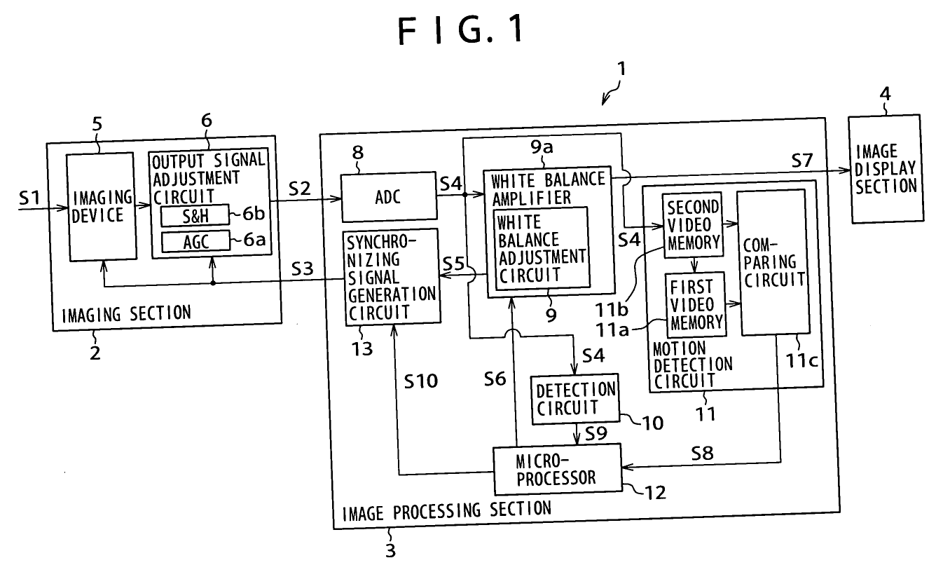

A surveillance camera apparatus 1 comprises, as shown in FIG. 1, an imaging section 2 for shooting an object, an image processing section 3 for processing an image data obtained by shooting at the imaging section 2, and an image display section 4 for displaying the image processed by the image processing section 3.

The imaging section 2 comprises an imaging device 5 such as a CCD (Charge Coupled Device) and a CMOS (Complementary Metal Oxide Semiconductor) sensor for photo-electrically converting an optical signal S1, and an output signal adjustment circuit 6 for adjusting an output signal from the imaging device 5. This imaging section 2 has a function of an electronic shutter which is able to determine the exposure time. Here, in this embodiment, the CCD and the CMOS sensor are exemplary described as the imaging device 5, however, the imaging device 5 is not limited to these sensors.

More specifically, the output signal adjustment circuit 6 comprises an AGC (Automatic Gain Control) circuit 6a, an S&H (Sample & Hold) circuit 6b, and the like.

The image processing section 3 comprises an ADC (Analog-to-Digital converter) 8 for converting an analog image data signal S2 inputted from the imaging section 2 into a digital image data signal S4 that is a digitized image signal, a white balance adjustment circuit 9 for applying the white balance adjustment to the digital image signal S4 converted by the ADC 8 to output a display image signal S7, a detection circuit 10 for outputting, on the basis of the digital image data signal S4, an image information signal S9, including luminance component data, color component data, and the like necessary for performing an exposure control, a motion detection circuit 11 for detecting the motion of the object on the basis of the digital image data signal S4, and a microprocessor 12 for controlling the white balance adjustment circuit 9.

Further, the image processing section 3 is provided with a synchronizing signal generation circuit 13 that generates and supplies a synchronizing signal S3 to the imaging section 2 to synchronize the imaging section 2 with the image processing section 3.

The white balance adjustment circuit 9 is provided with a white balance amplifier 9a that is a variable gain amplifier for amplifying or attenuating the digital image data signal S4 inputted from the ADC 8 to apply the white balance adjustment to one frame of image data in the digital image data signal S4 by changing a gain setting of the white balance amplifier 9a on the basis of a white balance control signal S6 inputted from the microprocessor 12.

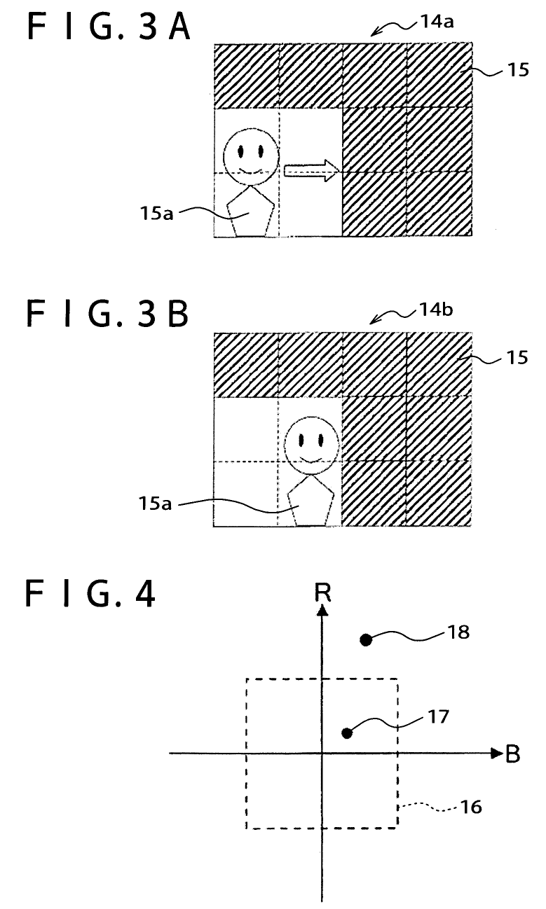

The motion detection circuit 11 comprises, as shown in FIGS. 1, 3A, and 3B, first video memory 11a for successively storing first image data 14b obtained from the digital image data signal S4 and a second video memory 11b for successively storing second image data 14a previously stored in the first video memory 11a, and a comparing circuit 11c for comparing the first image data 14b in the first video memory 11a with the second image data 14a in the second video memory 11b.

The comparing circuit 11c compares the first image data 14b with the second image data 14a by detecting the presence or the absence of the movement of the object 15a in the first image data 14b. Inversely, the movement information of the object 15a provides detection of still image data in the first image data 14b.

More specifically, the comparing circuit 11c divides the first image data 14b and the second image data 14a into a plurality of image blocks, respectively, to detect the presence or the absence of the movement of the object 15a by comparing image data between each pair of corresponding image blocks of the first and second image data 14b and 14a.

Further, still image blocks 15 where no movement of the object 15a exists are detected to supply position data of the still image blocks 15 as a position data signal S8 to the microprocessor 12.

The detection circuit 10 successively detects the color component data and the luminance component data from the digital image data signal S4 to generate the image information signal S9 that is supplied to the microprocessor 12. The microprocessor 12 detects the color component data at the still image blocks 15 from the image information signal S9 inputted from the detection circuit 10 and the position data signal S8 inputted from the motion detection circuit 11 to calculate the value of the spectrum characteristic of the illumination light source from the color component data.

Here, if the spectrum characteristic is calculated with only the image information signal S9 without the position data signal S8, the value of the spectrum characteristic of the whole of one frame of the image data can be calculated.

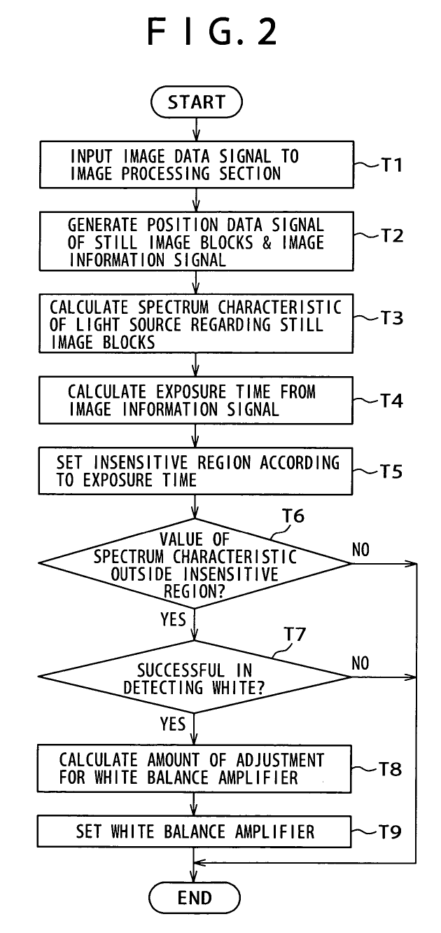

The microprocessor 12 calculates the exposure time for the imaging device 5 on the basis of the image information signal S9 inputted from the detection circuit 10, and generates a control signal S10, to be supplied to the synchronizing signal generation circuit 13, for controlling the exposure time of the imaging device 5 in accordance with the calculation result, and also changes the setting of the insensitive region 16 that is the color component region corresponding to a threshold value from where the white balance adjustment is started in accordance with the calculated exposure time as shown in FIG. 4. In this case, the insensitive region 16 represents a signal strength of the incoming signal. Further, the setting data of the insensitive region 16 may be provided anywhere as long as coping with the control of the flow chart in FIG. 2, and in the present embodiment shown in FIG. 1, the setting data is provided at either the microprocessor 12 or the white balance adjustment circuit 9.

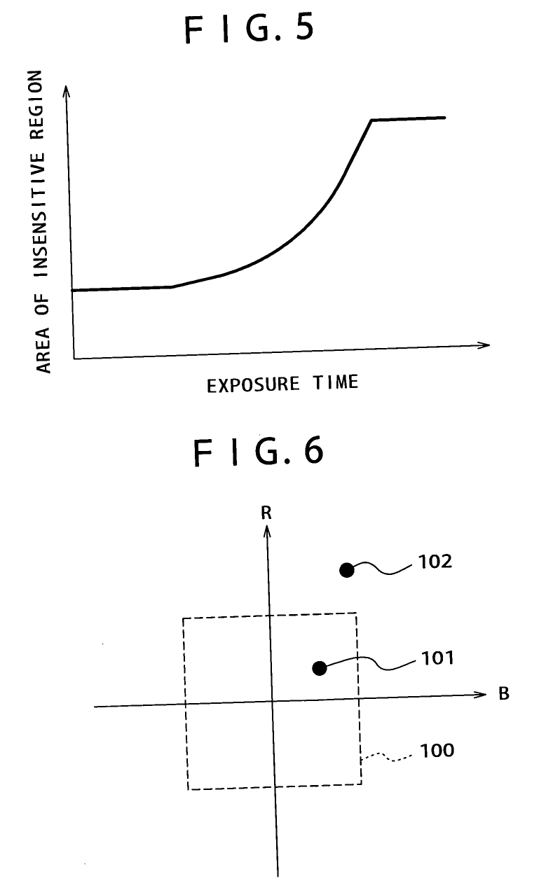

More specifically, as shown in FIG. 5, the setting is made such that when the exposure time is relatively longer, an area of the insensitive region 16 is relatively larger, and is gradually narrowed as the exposure time becomes shorter.

Further, the microprocessor 12 calculates a gain adjustment amount for the white balance amplifier 9a on the basis of the value of the spectrum characteristic and the insensitive region 16, generates a white balance control signal S6, and supplies this white balance control signal S6 to the white balance adjustment circuit 9.

The synchronizing signal generation circuit 13 generates a control clock signal S3 for the imaging section 2 on the basis of a image clock signal S5 inputted from the white balance adjustment circuit 9 and the control signal S10 inputted from he microprocessor 12, and supplies the control clock signal S3 to the imaging section 2 for synchronism of the imaging section 2 with the image processing section 3.

The image display section 4 comprises a known image display device such as an LCD (Liquid Crystal Display) and a CRT (Cathode Ray Tube) to display an image on the basis of the display image signal S7 inputted from the image processing section 3.

A method of adjusting the white balance according to the present invention will be described with reference to the flow chart shown in FIG. 2 and also to FIGS. 3A, 3B and 4.

First, as shown in FIG. 2, the analog image data signal S2 generated by the imaging section 2 upon shooting is supplied to the image processing section 3 (step T1).

In the image processing section 3, the ADC 8 converts the analog image data signal S2 into the digital image data signal S4 which is applied to the white balance adjustment circuit 9 as well as to the detection circuit 10, and the motion detection circuit 11.

In the motion detection circuit 11, the image data detected from the digital image data signal S4 is successively stored in the first video memory 11a and the second video memory 11b. The comparing circuit 11c divides, as shown in FIGS. 3A and 3B, the first image data 14b in the first video memory 11a and the second image data 14a in the second video memory 11b into a plurality of image blocks, respectively, and compares the first and second image data 14b and 14a between each corresponding pair of image blocks to detect still image blocks 15 where no motion (no variation) of the object 15a exist to generate the position data signal S8 of the still image blocks 15 that is supplied to the microprocessor 12.

Further, the detection circuit 10 successively detects the color component data and the luminance component data from the digital image data S4 to generate the image information signal S9 that is supplied to the microprocessor 12 (step T2).

The microprocessor 12 calculates the value of the spectrum characteristic of the illumination light source at still image blocks 15 with the image information signal S9 inputted from the detection circuit 10, and the position data signal S8 inputted from the motion detection circuit 11 (step T3).

After that, the microprocessor 12 calculates the exposure time of the imaging device 5 on the basis of the image information signal S9 inputted from the detection circuit 10.

Next, the insensitive region 16 is set in accordance with the exposure time of the imaging device 5 (see FIGS. 4 and 5). More specifically, as shown in FIG. 5, the setting is done such that when the exposure time is relatively longer, the area of the insensitive region 16 is relatively wide, and is gradually narrowed as the exposure time becomes shorter (step T5).

Upon shooting the object, the shorter the exposure time is, the higher the rate of occurrence of the color rolling phenomenon becomes, so that as the exposure time becomes shorter, the insensitive region 16 is set to be narrowed, and this increases the sensitivity in the white balance adjustment to allow the white balance adjustment to track the periodical variation in a color component due to the color rolling phenomenon.

Further, it is judged whether the value of the spectrum characteristic at the still image blocks 15 is inside or outside the insensitive region 16.

If the value of the spectrum characteristic at the still image blocks 15 is inside the insensitive region 16 (the point 17 in FIG. 4), that is, if the value of the spectrum characteristic is relatively even, the white balance adjustment is terminated.

On the other hand, if the value of the spectrum characteristic at the still image blocks 15 is outside the insensitive region 16 (the point 18 in FIG. 4), that is, if the value of the spectrum characteristic is deviated toward a color side, the white balance adjustment is continued (step T6).

After that, in step T4, if the value of the spectrum characteristic at the still image blocks 15 is outside the insensitive region 16, the white color detection is done inside the still image blocks 15 on the basis of the image information signal S9 of the still image blocks 15. If the white color cannot be detected, the white balance adjustment is terminated and if the white color is detected, the white balance adjustment is continued (step T7).

Further, an amount of variation for shifting the value of the spectrum characteristic at the white portion detected in step T5 to the inside of the insensitive region 16 is calculated, and the gain adjustment amount for the white balance amplifier 9a is calculated on the basis of the amount of variation to supply the white balance control signal S6 including a gain adjustment amount to the white balance adjustment circuit 9 (step T8).

Next, the white balance adjustment circuit 9 changes the gain settings of the white balance amplifier 9a on the basis of the white balance control signal S6 to apply the white balance adjustment to the digital image data S4 in order to determine the white color, and also performs color component adjustment regarding other colors on the basis of this white color, and then, terminates the white balance adjustment (step T9).

1. A color image processing method for a color imaging apparatus including an imaging unit for taking a color image to which an exposure interval is adjustable, a white balance amplifier for adjusting a white balance of a color video signal from the imaging unit, a detecting circuit for obtaining an image information signal out of the color video signal from the imaging unit, a motion detecting circuit for detecting a position data signal out of the color video signal from the imaging unit, and a control circuit for generating a white balance control signal based on the image information signal, wherein the white balance of the color imaging apparatus is adjusted by supplying the white balance control signal to the white balance amplifier, wherein;
said motion detecting circuit supplies the position data signal for a still image, and
in the white balance at the image area of the position data signal for the still image, a color component range defined by a threshold value from which an adjustment for the white balance amplifier is started is changed based on the exposure interval and the color component data.

2. The color image processing method as cited in claim 1, wherein
the color component range where the white balance is not carried out is gradually narrowed as the exposure time becomes shorter.

3. The color image processing method as cited in claim 1 or 2, wherein
the color component region where no white balance is carried out is changed only with respect to yellow and blue color components.

4. A color imaging apparatus comprising:
an imaging unit for taking a color image to which an exposure interval is adjustable;
a white balance amplifier for adjusting a white balance of a color video signal from the imaging unit, a detecting circuit for obtaining an image information signal out of the color video signal from the imaging unit;
a motion detecting circuit for detecting a position data signal out of the color video signal from the imaging unit; and
a control circuit for generating a white balance control signal based on the image information signal,
wherein the white balance of the color imaging apparatus is adjusted by supplying the white balance control signal to the white balance amplifier;
said motion detecting circuit supplies the position data signal for a still image; and
in the white balance at the image area of the position data signal for the still image, a color component range defined by a threshold value from which an adjustment for the white balance amplifier is started is changed based on the exposure interval and the color component data.
